(19) United States
(12) Patent Application Publication
(10) Pub. No.: US 2007/0184845 A1
(43) Pub. Date: Aug. 9, 2007

(54) Providing geographic context for applications and services on a wide area network

(76) Inventor: Edmund R. Troncoso, San Jose, CA (US)

Correspondence Address: COURTNEY STANIFORD & GREGORY LLP, P.O. BOX 9686, SAN JOSE, CA, 95157, US

(21) Appl. No.: 11/351,487

(22) Filed: Feb. 9, 2006

(51) Int. Cl. H04Q 7/20

(52) U.S. Cl. 455/456.1

(57) ABSTRACT

Embodiments of a method and system for providing geographic context for services delivered over a network, without user intervention, are described. In one embodiment, the geographic location of an access point on a wireless network, or a reference to the geographic location, is stored in the access point. The information can be in the form of latitude/longitude or street address. The access point makes this information available to mobile clients, carriers, or service providers by broadcasting this information at regular time intervals, or by responding to a query. A mobile client device searches for broadcasts of geographic location transmitted by an access point over a network, and retransmits any geographic location information in a first application layer protocol to a service provided by a server coupled to the access point over the network. The application accepts the geographic location of the access point as the geographic location of the client device.

### FIELD

Embodiments of the invention relate generally to data networks, and specifically to delivering services that require a geographic context to mobile device clients.

### BACKGROUND

The proliferation of local and wide area networks based on mobile wireless devices has led to the development of services and applications that require, or are enhanced by knowledge of the geographic location of the mobile client device. Such services can include emergency response services, such as E911, that utilize the location of the user's phone or mobile device to quickly provide assistance. The integration of geographic location information of a mobile client device into the service or application utilized by the client device, however, is not always possible due to the inability to accurately determine client device location and/or integrate this information into the service protocol.

Some methods for allowing client devices to determine geographic location are presently known, and include using GPS (Global Positioning System) enabled devices, databases of mapped access points, or triangulation of multiple wireless signals, such as television stations. However, these methods generally have limitations that reduce their usefulness in many services that require geographic location. For example, GPS signals require an unobstructed view of the sky and are easily absorbed in tunnels and buildings, thus rendering GPS-based devices nearly useless in buildings or densely packed cities. Other wireless devices may suffer from multi-path propagation in metropolitan areas. Furthermore, the WLAN (Wireless Local Area Network) radio and the radio types typically used for geographical identification are usually different, and there may be conditions under which network connectivity would be available when accurate location information is not. In addition, these methods require that clients include additional radio technology, which cannot always be implemented in every type of wireless client device.

An additional disadvantage associated with GPS devices, is that the GPS device must determine its own location. If this location information is used by a separate application service provider that is coupled to the GPS device over a network, it must first be sent to the network operator's Service Mobile Location Center (SMLC), thus requiring additional transmission and processing steps, and potentially limiting access and availability of this location information.

Wide Area Networks (WANs), such as cellular wireless phone systems, are generally controlled by a single carrier, so that geographic information about each wired or wireless point of network access is usually known by the carrier. Such knowledge allows for mobility and geographic tracking of mobile networked clients through known methods, such as tower identification, or use of other advanced methods for refinement, such as triangulation using radio signals from multiple access points. However, interchange across a WAN, or a collection of LANs, require that explicit methods be used to pass geographic information from one carrier to another.

Although various network methods may allow a user to determine the location of a mobile client device, such methods do not easily and efficiently determine the location information and pass it on to application service providers for incorporation into applications that used by the mobile client device, or that require the location information. Methods of geographic location determination, such as Angle of Arrival (AOA), Uplink Time Difference of Arrival (U-TDOA), Wireless Location Signatures, Enhanced Cell Identity (E-CID), Advanced Forward Link Trilateration (A-FLT), Enhanced Observed Time Difference (E-OTD), and other similar methods, generally determine the location of a mobile client device by in relation to transmitters, such as cell towers or radio towers, using triangulation or similar techniques. These methods, however do not provide the location information to the mobile client device itself, nor do they provide this location information to a separate application service provider in a manner that enables third party service providers to easily determine and incorporate the location information (apply geographic context) into applications that may be used by the mobile client device. Moreover, these methods generally require strict control by a single network operator, and thus are inappropriate for the determination and use of geographic location data of any mobile device across a WAN or collection of LANs.

Industry groups, such as the National Emergency Number Association (NENA), which offers recommendations for the interchange of E911 location information between network operators and Public Safety Answering Points (PSAP), is currently active in defining the VoIP Emergency Services Gateways (ESGW), to transfer emergency service requests from VoIP to the SS7 network used for emergency services. These recommendations do not, however, suggest how the geographic location is to be determined, how it is transmitted over the TCP/IP network to the ESGW, or how it can be used in other non-emergency applications.

In a TCP/IP network, geographic information must be addressed at the Application layer (Layer 5 of a TCP/IP network model) to support the widest range of applications. Since WAN switching generally operates at the Link layer (Layer 2 of the TCP/IP model), and LANs generally route traffic using the Network layer (Layer 3 of the TCP/IP model), both WANs and LANs ignore the Application layer data encapsulated in the packets.

It is possible to establish a protocol below the IP layer that shares geographic information. This approach has been used for some non-IP networks, however, to use this on an IP network would require changes to the networking stack of all devices on the network, including routers and switches, rather than limiting the changes to clients and access points. Many of the additional affected devices function at the hardware level on the existing IP standards, and may therefore require replacement rather than upgrade.

As an example, there are patented methods for devices with limited networking stacks coupled with IP data insertion by an access point with stored geographic information. Such methods use a limited network stack in a handheld device, which communicates solely with a pre-determined access point. The access point accepts the limited data protocols from the client, then inserts the data into an IP packet, along with additional information, such as geographic locations, into IP data packets for forwarding along an IP-based network. This method has the advantage of reduced client cost, since the client uses a smaller networking stack and less processing power. However, these devices are also tied to a location (no mobility), and limited in functionality to the specific applications supported by the access point in that location.

Considering the known methods, there currently is no effective method for passing geographic information discerned by a LAN administrator or carrier from the Network layer up to the Application layer, where a service provider might be able to use the geographic information to apply a geographic context to the services. As a result, services that require geographic context currently require users to enter their geographic information manually, either one location per service session or one location for all service sessions. For some services, however, such as emergency services, the user of a client may not have the time or data entry capabilities to enter such information. This problem is exacerbated for mobile clients, since the mobile client's location may change between service sessions, and potentially during the service session. These services thus require a more automated approach to generating geographic information and transmitting it to the service provider.

### BRIEF DESCRIPTION OF THE DRAWINGS

Embodiments of the present invention are illustrated by way of example and not limitation in the figures of the accompanying drawings, in which like references indicate similar elements and in which:

FIG. 1 illustrates a network that implements a geographic context provision method for network devices, according to an embodiment.

FIG. 2 is a flowchart that illustrates the overall method of determining and utilizing geographic location information of a client device, according to an embodiment.

FIG. 3 illustrates methods of inserting location data into an access point, according to an embodiment.

FIG. 4 illustrates a method of autonomously deriving and inserting location data into an access point, according to an embodiment.

FIG. 5 illustrates a method of autonomously deriving access point location data, according to an alternative embodiment.

FIG. 6 illustrates a query by a client device, according to an embodiment.

FIG. 7 illustrates the storage of the access point location data in a remote data storage, under an embodiment.

FIG. 8 illustrates a query for routing among several different service providers based on geographic context, according to an embodiment.

FIG. 9 illustrates the refinement of queried geographic data by a client, under an embodiment.

FIG. 10 illustrates protocol insertion at the access point, according to an embodiment.

### DETAILED DESCRIPTION

Embodiments of a method and system for providing geographic context for services delivered over a network, without user intervention, are described. In one embodiment, the geographic location of an access point on a wireless network, or a reference to the geographic location, is stored in the access point. The information can be in the form of latitude/longitude or latitude/longitude/elevation, or it can be represented and stored in other formats, such as street address/suite/floor. The access point makes this geographic information available to mobile clients, carriers, or service providers by broadcasting this information at regular time intervals, or by responding to a query. The geographic data is delivered in an unencrypted form which can be accessed by the mobile clients regardless of whether or not the device has authorization to access the access point's network. A mobile client device searches for broadcasts of geographic location transmitted by an access point over a network, and retransmits any geographic location information in a first application layer protocol to a service provided by a server coupled to the access point over the network. The application accepts the geographic location of the access point as the geographic location of the client device.

In the following description, numerous specific details are introduced to provide a thorough understanding of, and enabling description for, embodiments of a link assessment and frequency monitoring system for a wireless sensor network. One skilled in the relevant art, however, will recognize that these embodiments can be practiced without one or more of the specific details, or with other components, systems, and so on. In other instances, well-known structures or operations are not shown, or are not described in detail, to avoid obscuring aspects of the disclosed embodiments.

In one embodiment, a network client is configured to read geographic data provided by an access point during the execution of applications or the transmission of data that require geographical data. Under this embodiment, when a network client initiates a transmission that requires geographical context, the client executes a software routine that reads the geographic data that is broadcast from the access point. This data is inserted into the application protocol by the client, thus allowing an accurate and compatible geographical context for the network service. For networks that have limited range, such as 802.11 networks, the physical location of the access point is sufficient to identify the location of the client for many applications.

To further refine the geographic location of the mobile client, that client can read broadcasts from multiple access points, and can use the relative strength of the access points (such as provided in IEEE 802.11r). To enable this refinement, and geographic context determination, the broadcasts are transmitted in unencrypted form, so that the client can obtain the geographic information regardless of whether or not the access points are on the same network, or whether the client can access the network of the access points.

The geographic information can be passed to applications on other types of communication networks, such as cellular networks, to offer greater location refinement than is available on these other types of communications. For such an application, the client may determine its location without having access to any of the IP networks.

There may be cases in which a carrier or service provider may offer additional or refined services based on location, while the network client is unaware of the need for geographic context. In these cases, the access point may respond to a network query from a carrier or service provider. In one embodiment, this is accomplished through an embedded server. In this case, when a network client initiates a transmission which requires geographical context, but supplies no geographic context, the service provider or carrier can query that information and the access point responds with its own geographic location data. The service provider or carrier can then use this information as part of the geographic context for the client.

Under an alternative embodiment, the access point is configured as an intelligent access point that can inspect packets to scan data for certain types of known application protocols, and upon identifying a specific type of traffic, can insert the geographic data into the application protocol. This allows geographic context without intervention of the client, service provider or carrier for certain applications.

Aspects of the one or more embodiments described herein may be implemented on one or more computers executing software instructions. The computers may be networked in a client-server arrangement or similar distributed computer network, and one or more links of the network may implement wireless communication protocols.

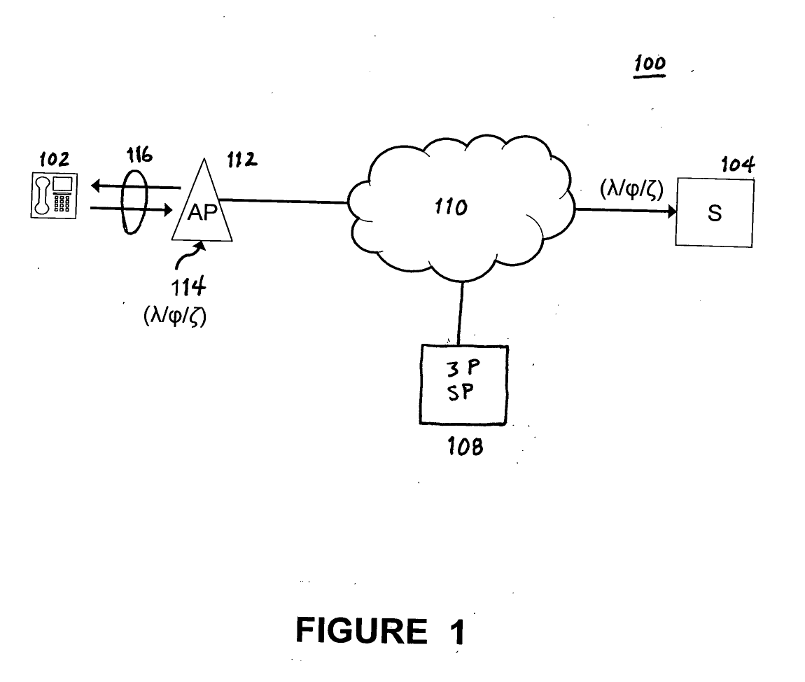

FIG. 1 illustrates a computer or electronic device network system 100 that implements one or more embodiments of a geographic context provision method for network devices. In system 100, a network server computer 104 is coupled, directly or indirectly, to one or more network client devices 102 through a network 110. The network interface between server computer 104 and client device 102 may also include one or more routers that serve to buffer and route the data transmitted between the server and the clients. Network 110 may be the Internet, a Wide Area Network (WAN), a Local Area Network (LAN), or any combination thereof.

In one embodiment, the server computer 104 is a computer maintained by a service provider that provides one or more services to users of client device 102. For the embodiment in which network 110 is a TCP/IP network (e.g., the Internet), the service may be delivered using protocols in the TCP/IP Application layer. The services may be served from the LAN, by a carrier, or from a third party service provider 108 with no affiliation to either the LAN administrator or the carrier.

The client device 102 may be coupled to the network 110 in one of several different ways. It may be coupled to network 110 through a wired LAN that is physically connected to the network infrastructure by cabling or wires. More typically, however, it is coupled through a wireless LAN (WLAN), and it is configured to use radio or infrared or similar wireless means to connect to the network. In one embodiment, the client 102 is an IP-based WLAN device that uses one of the 802.11 IEEE standards, such as 802.11a, 802.11b, or 802.11g. For this embodiment, the client device has a practical range limitation of approximately 60-300 feet from the access point due to 802.11 specifications. The client device 102 may also be connected to network 110 through a Wide Area Network (WAN), such as a cellular wireless phone system. For this embodiment, the client-side connection is generally controlled by a single carrier.

For the embodiment illustrated in FIG. 1, the client device 102 accesses network 110 through an access point 112 over a client side LAN 116. In general, the access point provides utilities or physical points of contact that allows the client 102 to connect with network 110 and perform data transmissions to other devices or computers coupled to the network.

In one embodiment, server 104 in network system 100 is a server computer or device that executes an application serving process, and the client device 102 is a processing device that executes aspects of the service provided by server 104 along with a geographic context process. These processes may represent one or more executable programs modules that are stored within the server and client and executed locally within the respective devices. Alternatively, however, they may be stored on a remote storage or processing device coupled network 110 and accessed by server 104 and client 102 to be locally executed.

The client device 102 is typically a mobile device, such as a mobile phone/communication device, laptop computer, personal digital assistant (PDA) or similar device that has no required fixed location during use. In one embodiment, the geographic location of the access point is used to derive the location of the mobile device for applications or services provided by server 104 or third party service provider 108 that may require or benefit from the geographic location of the client device 102.

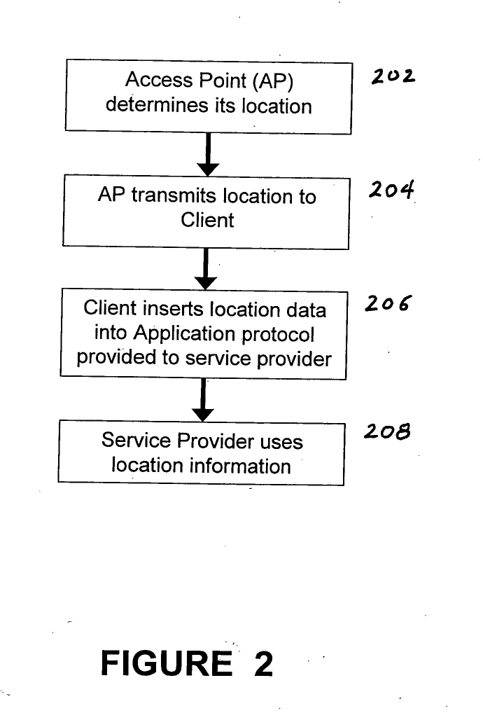

FIG. 2 is a flowchart that illustrates the overall method of determining and utilizing geographic location information of a client device, according to an embodiment. In 202 the access point determines its location. This can be done using one of several different methods, such as user input of latitude/longitude/elevation (λ/φ/ζ) or street address data, or by direct input of GPS coordinates, or by download of location data from a pre-defined access point database. Once the access point location data is defined, it is transmitted to the client, 204. The transmission from the access point to the client can be done using a broadcast method or in response to a query, as described in greater detail below. The client then inserts or causes the location information to be inserted into the application protocol provided to the service provider, 206. The service provider then uses the location information in the appropriate manner required by the service, 208. If necessary, the service provider may convert the address from a format provide by the access point to a different format, for example, from global coordinates to street address format.

As shown in system 100, geographic location data (λ/φ/ζ) 114 is stored in the access point 112, either in explicit form, or through a pointer to data stored remotely on a network. The information can be entered into the access point through a number of methods, including through a local communication port, by web-based interface, by remote management by a network administrator or service provider, or in an autonomous manner by probing geographic information from surrounding access points.

In one embodiment, the access point may broadcast its geographic location data in the form of an array of floating point values representing longitude (X coordinate, λ), latitude (Y coordinate, φ) and elevation (Z Coordinate, ζ). Alternatively, this data may be in the form of an array of alphanumeric fields, in order to conform with geographic data interchange standards or recommendations (e.g., National Emergency Number Association technical documents). If the data is to be broadcast only to devices which can access its network, the data may be sent in encrypted form. In other instances, the data can be broadcast in unencrypted form.

When the client device receives the geographic data, a software routine passes the data up the network stack, where an application can interpret this data, determine any conversions that might be necessary for the desired network service, such as floating point to alphanumeric formats. Once the appropriate conversion has been made (and assuming the user has approved broadcast of geographic information, as regulatory bodies may require) the application then inserts the geographic data into an application protocol that is appropriate for the desired network service, and transmits the results to the network service provider through whatever network it has available. This may be the network of the access point, or some other available network.

To further support integration into the broadest range of services while minimizing the processing load on the client device, more complex data conversions, such as (λ/φ/ζ) to (street address/city/state), can be performed by the service provider or through a third party service provider. This conversion model is similar to the use of a Serving Mobile Location Center (SMLC) in cellular networks, though it is a simpler approach, since traditional SLMC's often compute geographic data rather than simply converting or reformatting it. In addition to offloading processing power from client devices for complex formatting and conversion, this approach allows service providers to modify their protocols for enhancements and refinements without having to update the software for all client devices.

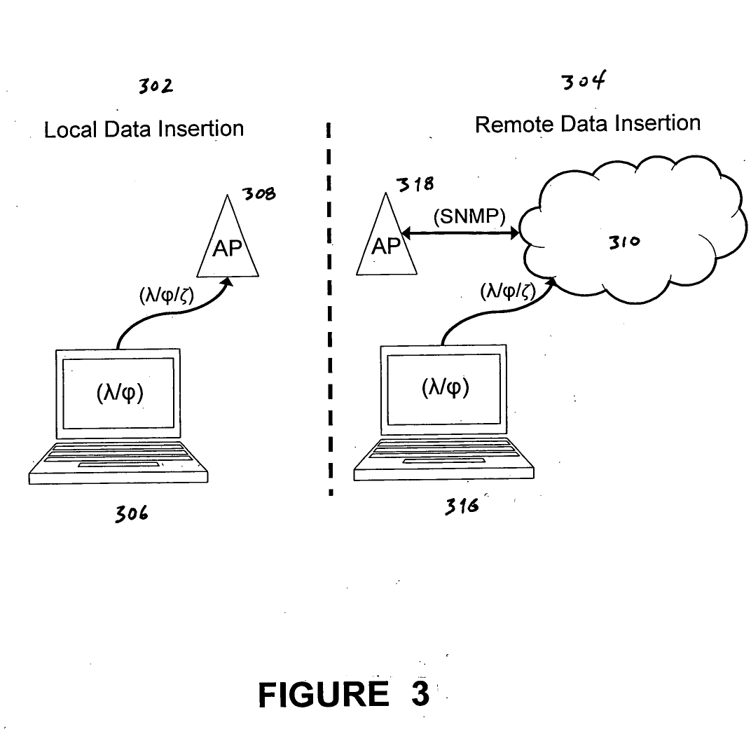

FIG. 3 illustrates methods of inserting location data into an access point, according to an embodiment. Under the local data insertion method 302, geographic location data (λ/φ/ζ) provided by a terminal or data source 306 is directly downloaded to access point 308 through a local communication port (e.g., serial port, USB, etc.) and stored in the access point. In the remote data insertion method 304 the access point 318 is remotely identified over a network 310 and managed by either a web-based (HTTP, HTTPS) interface or using a network management protocol, such as SNMP (Simple Network Management Protocol). A remote terminal 316 uses remote management to read, enter and modify the geographic location data (λ/φ/ζ) stored in the access point 318.

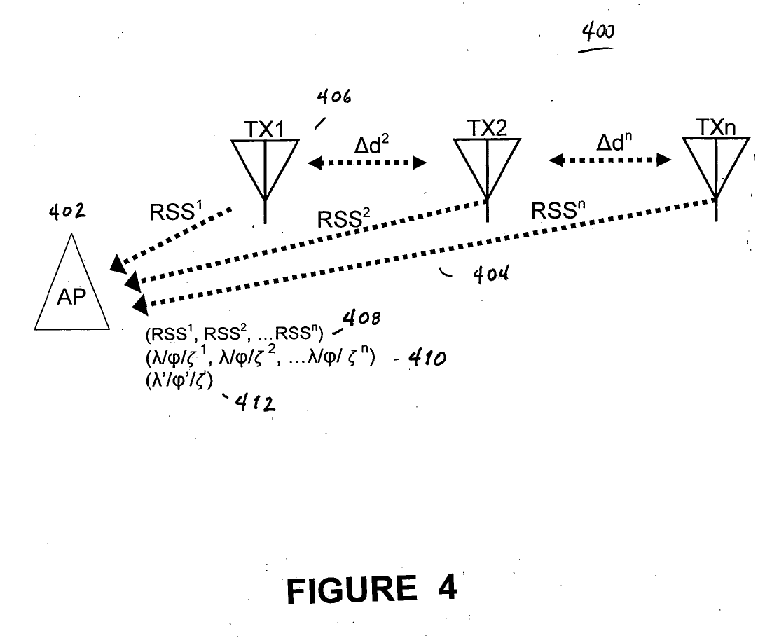

FIG. 4 illustrates a method of autonomously deriving and inserting location data into an access point, according to an embodiment. In system 400, the access point 402 determines the relative strengths of a plurality of available radio signals 404 from known antenna locations 406, denoted TX1-n. The antennas and signals can be any type of medium/long range transmission, such as television, FM radio, cell, and so on. The access point 402 uses the signal strength (RSS¹⁻ⁿ) and characteristics 408, along with the known antenna locations (λ/φ/ζ)¹⁻ⁿ 410 to derive its own geographic location using triangulation techniques, or similar methods. The resulting location information (λ′/φ′/ζ′) 412 is then stored as the geographic location of the access point 402.

Under the autonomous approach illustrated in FIG. 4, the access point can act as a client by executing a process that probes the surrounding access points for geographic location, and uses triangulation when multiple access points are available. This allows deployments to automatically configure the locations of access points, or allow access points to self-determine their location if they are moved. Since location data can be considered relatively static, the stored data (or the pointer to location data) is typically stored in flash memory or some other form of non-volatile memory in the access point or a storage device coupled to the access point.

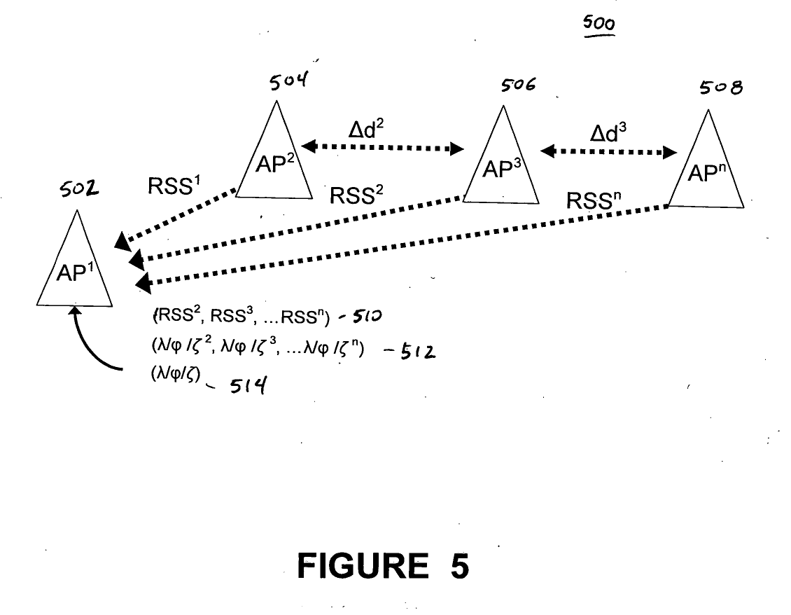

Instead of deriving the location data from disparate radio sources, such as towers 406 shown in FIG. 4, the access point can derive its location information from other access points, if they are available. FIG. 5 illustrates a method of autonomously deriving access point location data, according to this alternative embodiment. In system 500, the access point 502 determines the relative signal strength (RSS) 510 of a plurality of available access points 504-508 (AP²⁻ⁿ). Access point 502 reads the broadcast of the geographic locations from each of the identified access points for their stored geographic locations (λ/φ/ζ)²⁻ⁿ 512. Access point 502 uses the RSS 510 and locations 512 to derive its own geographic location (λ/φ/ζ) 514 using triangulation, or similar methods. The result is then stored as the geographic location of access point 502.

Once the access point has been provided with its geographic location data, it is available for use by the client 102 and is transmitted to the client, as shown in element 204 of FIG. 2. In one embodiment, the access point broadcasts this information to any appropriate client within range. Alternatively, the client or clients within range query the access point for the location information, and the access point responds to the query. The query can be initiated by the client, the client-side network carrier, or the service provider 104. The location information may be encrypted. More typically, however, the access point may be configured to broadcast or receive and respond to a query in an unencrypted manner, regardless of whether or not the client can register with the access point for any other network services.

For the embodiment in which the access point broadcasts its location information to the client device, a broadcast schedule must be defined. The broadcast from the access point can be programmed to occur at regular periodic intervals. Alternatively, the access point can be configured to broadcast its location information when a new client enters the vicinity of the access point by coming within a pre-defined range or a detectable range, or when a new client registers with the access point for other network services. The advantage of broadcasting over the client network is that the access point does not have the burden of doing packet inspection of traffic from unauthorized clients while looking for a query.

For the broadcast method, periodic broadcasts over defined time intervals is generally preferred, as it requires the least processor overhead on the access point, and allows the amount of broadcast traffic to be controlled. Broadcasting only when a new client appears can lead to excessive broadcasts in high traffic areas, and leaves the access point vulnerable to attack through excessive or repetitive appearances or disappearances of a client, with the result being similar to a Denial of Service attack. Broadcasting only when a new client registers with the access point is an option for closed networks, but may limit the ability for a client to access location data for refinement of location in critical applications, like E911 services. Under an embodiment, the broadcast range is limited to the client network segment 116. In this case, the location information generally does not propagate beyond the LAN segment, and would therefore not be available to service providers except through a more targeted queries.

For the embodiment in which the access point transmits its location information to the client device in response to a query, this transmission can be triggered by one or more conditions. The access point can be configured to transmit its location information when the client directly queries the access point. Alternatively, the query can be triggered by a service provider requiring geographic location context for the client. For the case in which a client initiates a service that requires a geographic context, it queries the access point for the geographic information, and the access point responds with the location information. For the case in which a carrier or service provider initiates a service that requires a geographic context, the carrier or service provider can query the access point at which the client is registered. The service can then use the location data as the geographic context of the service. The advantage of the query method over the client network is that this traffic over the wired network between the access point and the network 110 can be assumed to be authorized, including traffic from service providers.

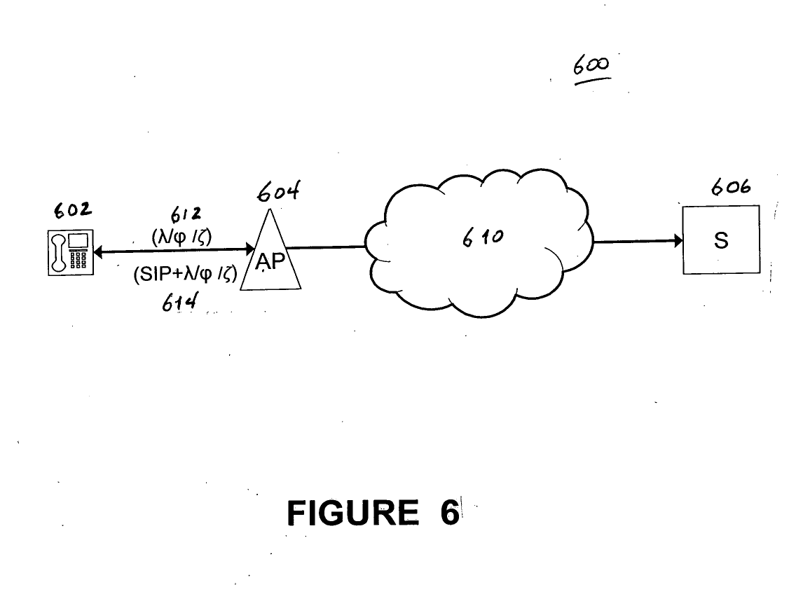

FIG. 6 illustrates a query by a client device, according to an embodiment. In system 600, a client 602 utilizing access point 604 and intending to initiate a session for a service 606 that requires a geographic context, queries the access point for its geographic location data. The access point 604 responds to the query with its stored geographic information 612. The client 602 then uses the geographic location stored in the access point as the geographic context for the service.

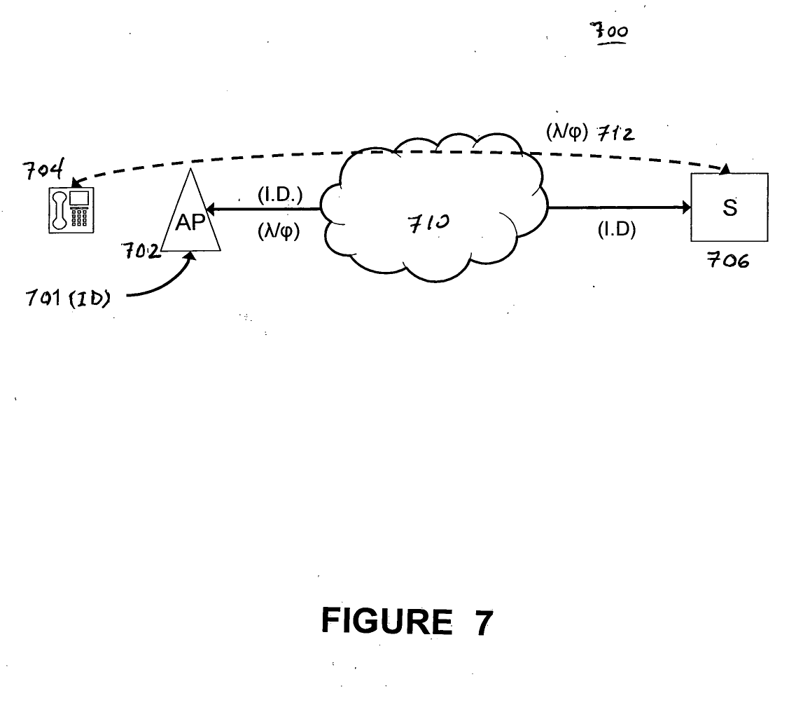

When the embodiment uses the query method, rather than the broadcast method, on a large managed networks where a centralized asset management system is implemented, the location data for the access point can be stored in a remote data storage. FIG. 7 illustrates the storage of the access point location data in a remote data storage, under an embodiment. In system 700, the Access Point 702 is remotely identified (ID) using its MAC (Media Access Control) address or a uniquely generated number which can be stored in the access point, and managed by a web-based interface, or using a known network protocol. A remote system 706 stores a database which includes both the geographic location of each access point in its network and the unique identifier (ID) for that access point (the MAC address or the uniquely generated number). When a client queries an access point for its location, the remote system 706 correlates queries from the client using the access point 702 with the access point's geographic location data using the identifier and serves 712 the geographic data as a network service to support applications for clients 704 using the access point 702. This embodiment is most appropriate for campus networks, where access is controlled, assets may be frequently relocated or replaced, and remote network management is utilized.

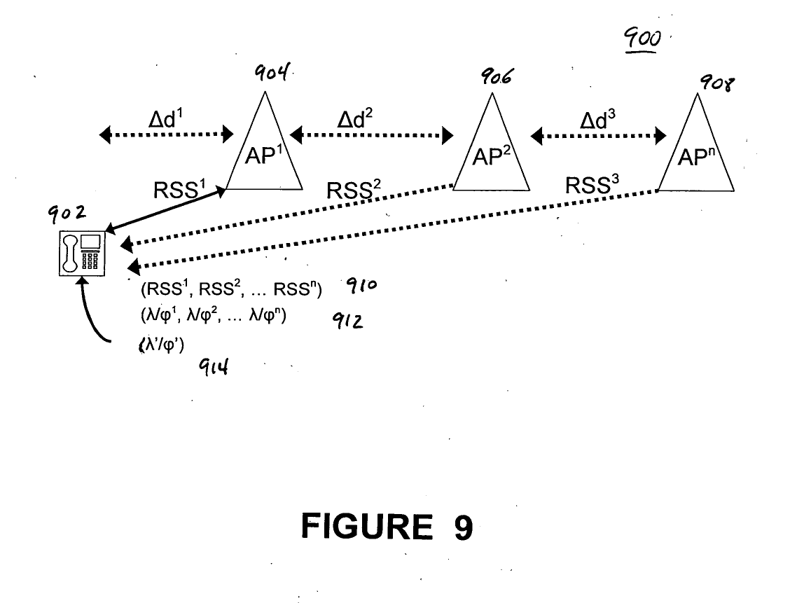

Under an embodiment, a service requiring a geographic context can assume that the client is in the same geographic area as the access point it is using provided that the network media of the client network 116 (wire or radio range of the wireless network) does not exceed the usable geographic range of the service. For services that require a greater degree of granularity in geographic context, the client device can be configured to scan traffic on the wireless network (such as by frequency hopping transmissions using spread spectrum) and query some, or all, available access points for location information. The client device can then judge the relative strengths of each access point signal to help refine the geographic positioning data. FIG. 9 illustrates the refinement of geographic data by a client, under an embodiment using the query method. In system 900, a client 902 utilizing access point 904 determines the relative signal strength (RSS) 910 of a plurality of available access points 906-908. The client 902 queries each of the identified access points and obtains their stored geographic locations (λ/φ)¹⁻ⁿ 912. The client 902 uses the relative signal strengths and locations of the access points 906-908 to refine the geographic location (λ/φ) obtained from access point 904 using triangulation, or similar methods. The resulting location data (λ/φ)¹ 914 is then used as the geographic location of client 902. Besides received signal strength (RSS), other methods may be used to provide refinement of the location of the client device.

For the embodiment in which client network 116 is an 802.11 protocol (e.g., 802.11a, b, or g), the limited range offers immediate accuracy for geographic data. Because 802.11 is a relatively cost-effective protocol, an increasing number of LANs are being implemented with this technology. Thus, the widespread adoption of these wireless networks increases the chances that triangulation will offer results that can be even more accurate than physical locators, such as street addresses.

As shown in FIG. 2, once the client has received the location information from the access point, it inserts it into the application protocol provided by the service provider, 206. For the embodiment in which network 110 is a TCP/IP network, the geographic information is inserted at the Application layer (Layer 5 of a TCP/IP network model).

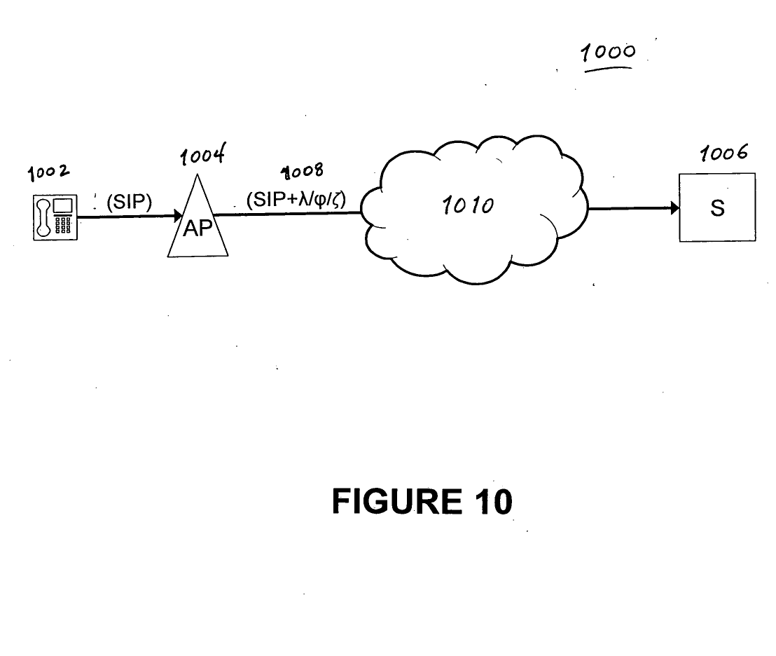

In an alternative embodiment, the access point may be an intelligent access point that is configured to inspect packets for context sensitive services, such as an Emergency VoIP call, (Voice Over IP) and insert the geographic information into the application protocol itself. FIG. 10 illustrates protocol insertion at the access point, according to an embodiment. In system 1000, a client device 1002 utilizing access point 1004 initiates a session for a service 1006 which requires a geographic context. The access point 1004 performs Stateful Packet Inspection (SPI) or a similar method of traffic analysis, and identifies the service requirement. The access point 1004 modifies the session initiator to include the geographic location data 1008 stored in the access point.

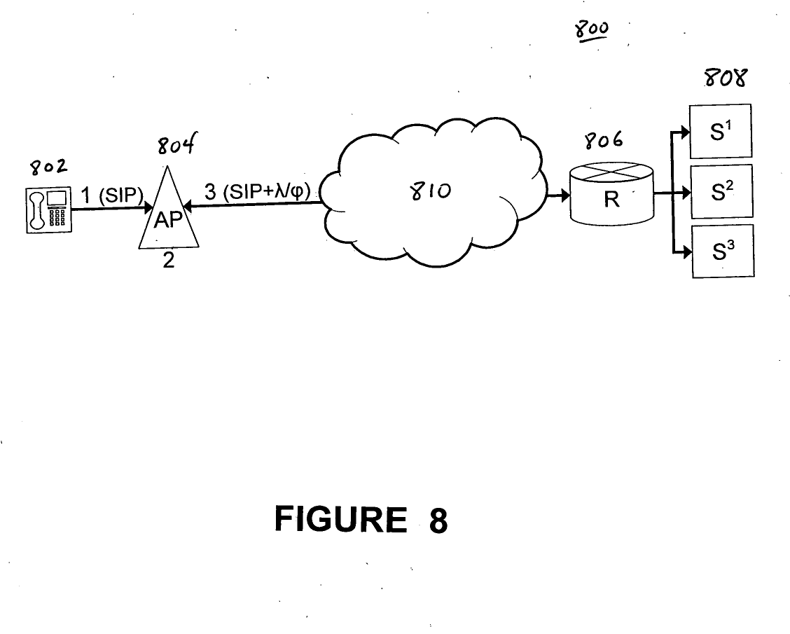

In some cases, a service may be implemented through a number of separate regional service providers, and the service request is routed to the most appropriate service provider based on its geographic context. As illustrated in FIG. 6, the client may forward the geographic data so that it may be appropriately routed. As an alternative, an access point using a method of packet inspection may also supply the geographic information for routing purposes. FIG. 8 illustrates a query for routing among several different services, according to an embodiment. In system 800, a client device 802 utilizing access point 804 initiates a session for a service 808 which is offered by a plurality of service providers for specific geographic regions. The access point 804 performs a stateful packet inspection (SPI), or some other known method of traffic analysis, and identifies the service requirement. The access point then inserts its own geographic data into the session initiator or other application protocol. Router process 806 then routes the service requirement to the appropriate regional service provider for the service 808.

As shown in element 202 of FIG. 2, the access point must determine or have its location defined. The location of an access point can be determined and programmed one or more different ways. One method is to locally insert geographic data. This method can be utilized when the geographic data is already known, or when a database is accessible to correlate street address to latitude, longitude and elevation.

A third method is obtaining the data through a GPS receiver, either externally or embedded into the access point directly. This method can be utilized in areas where GPS signals are not obstructed.

A fourth method is HDTV signal triangulation, which requires that additional HDTV circuitry be used, either externally or embedded into the access point directly.

A fifth method that can be utilized in managed networks, such as campus LANs, is to maintain a wireless access point inventory in the form of a database. The location of each access point within a network is defined or provided by the network operator, and this location is maintained in a database that is accessed by the access point to determine its location.

When databases are to be used, there are a number of methods for determining the location data of the access point. One method is to require the input of a street address for the access point. The address can then be correlated against mapping data to determine latitude, longitude and elevation. This can be accomplished through a manual process, such as a web page, or through an automated service which remotely loads the geographic data into the access point, similar to the remote method described in FIG. 3.

A second method is by access point mapping and triangulation. This method utilizes the unique profile of each access point. A service provider generates a map of all access points in a region by traversing the region and trying to identify all access points in that region. This information is then stored in a database that can be accessed by the service provider. A map can be developed that will work across service providers and individual users, and without service provider involvement. This approach generally requires that changes to the environment, such as the addition of radios, the removal or replacement of radios, or the introduction of other types of radio signals that would lead to changes in the profile, and therefore result in false readings, must be monitored and accounted for. As a result, this approach requires regular updates, which can be time-intensive, making the database vulnerable to becoming out-of-date quickly.

Embodiments of the geographic location determination and insertion method can be used by service providers in various fields such as voice service providers, Emergency 911 dispatch, or other services that require accurate geographic context. The method described here allows any mobile client with Internet Protocol (IP) support to accurately determine its geographic location from wireless access points. This may allow service providers not only to meet government mandates, but to also offer a new generation of services that transparently use this location data, such as vendor, product and service searches and location-specific advertising, without owning, controlling or mapping the network.

Embodiments of providing geographic context for network services as described herein can be used in various different applications, industries or industry segments, such as local or wide area networks for mobile client devices devices, or local or wide area networks for computing devices, and the like. The clients can be simple sensors, or sophisticated computing devices, or combinations thereof. They may be statically placed or they may be movable within defined areas of the network. The links between the clients may encompass one or more frequency channels, some of which may utilize either hard-wired or wireless communication means.

The network may be a single access point-multiple client network, such as that shown in FIG. 1, or it may be a network that contains multiple access points, or enhanced capability access points that can perform operations according to embodiments.

Aspects of the geographic location determination system described herein may be implemented as functionality programmed into any of a variety of circuitry, including programmable logic devices (“PLDs”), such as field programmable gate arrays (“FPGAs”), programmable array logic (“PAL”) devices, electrically programmable logic and memory devices and standard cell-based devices, as well as application specific integrated circuits. Some other possibilities for implementing aspects of the geographic location determination system include: microcontrollers with memory (such as EEPROM), embedded microprocessors, firmware, software, etc. Furthermore, aspects of the described method may be embodied in microprocessors having software-based circuit emulation, discrete logic (sequential and combinatorial), custom devices, fuzzy (neural) logic, quantum devices, and hybrids of any of the above device types. The underlying device technologies may be provided in a variety of component types, e.g., metal-oxide semiconductor field-effect transistor (“MOSFET”) technologies like complementary metal-oxide semiconductor (“CMOS”), bipolar technologies like emitter-coupled logic (“ECL”), polymer technologies (e.g., silicon-conjugated polymer and metal-conjugated polymer-metal structures), mixed analog and digital, and so on.

It should also be noted that the various functions disclosed herein may be described using any number of combinations of hardware, firmware, and/or as data and/or instructions embodied in various machine-readable or computer-readable media, in terms of their behavioral, register transfer, logic component, and/or other characteristics. Computer-readable media in which such formatted data and/or instructions may be embodied include, but are not limited to, non-volatile storage media in various forms (e.g., optical, magnetic or semiconductor storage media) and carrier waves that may be used to transfer such formatted data and/or instructions through wireless, optical, or wired signaling media or any combination thereof. Examples of transfers of such formatted data and/or instructions by carrier waves include, but are not limited to, transfers (uploads, downloads, e-mail, etc.) over the Internet and/or other computer networks via one or more data transfer protocols (e.g., HTTP, FTP, SMTP, and so on).

Unless the context clearly requires otherwise, throughout the description and the claims, the words “comprise,” “comprising,” and the like are to be construed in an inclusive sense as opposed to an exclusive or exhaustive sense; that is to say, in a sense of “including, but not limited to.” Words using the singular or plural number also include the plural or singular number respectively. Additionally, the words “herein,” “hereunder,” “above,” “below,” and words of similar import refer to this application as a whole and not to any particular portions of this application. When the word “or” is used in reference to a list of two or more items, that word covers all of the following interpretations of the word: any of the items in the list, all of the items in the list and any combination of the items in the list.

The above description of illustrated embodiments of the geographic location determination system is not intended to be exhaustive or to limit the embodiments to the precise form or instructions disclosed. While specific embodiments of, and examples for, the geographic location determination system are described herein for illustrative purposes, various equivalent modifications are possible within the scope of the described embodiments, as those skilled in the relevant art will recognize.

The elements and acts of the various embodiments described above can be combined to provide further embodiments. These and other changes can be made to the geographic location determination system in light of the above detailed description.

In general, in the following claims, the terms used should not be construed to limit the described system to the specific embodiments disclosed in the specification and the claims, but should be construed to include all operations or processes that operate under the claims. Accordingly, the described system is not limited by the disclosure, but instead the scope of the recited method is to be determined entirely by the claims.

While certain aspects of the geographic location determination system are presented below in certain claim forms, the inventor contemplates the various aspects of the methodology in any number of claim forms. For example, while only one aspect of the geographic location determination system is recited as embodied in machine-readable medium, other aspects may likewise be embodied in machine-readable medium. Accordingly, the inventors reserve the right to add additional claims after filing the application to pursue such additional claim forms for other aspects of the described system.

What is claimed is:

1. A method of providing geographic location of a mobile client device comprising:
searching for broadcasts of geographic location transmitted by an access point over a network; and
resending found geographic location information in a first application layer protocol to a service provided by a server coupled to the access point over a network, wherein the application accepts the geographic location of the access point as the geographic location of the client device.

2. The method of claim 1, wherein the network comprises the Internet, and wherein the geographic information is inserted at the Application layer of a TCP/IP network model.

3. The method of claim 2, wherein the geographic location is broadcast to the client device at pre-defined time intervals.

4. The method of claim 3, wherein the geographic location is broadcast to the client device in a second application layer protocol.

5. The method of claim 2, wherein the geographic location is transmitted to the client device from the access point in response to a query transmitted from the client device to the access point.

6. The method of claim 2, wherein the geographic location of the access point is determined by one of data derived from user input, data derived from a database lookup operation, and data derived by a global positioning system device.

7. The method of claim 6, wherein the geographic location comprises one of latitude, longitude, elevation data, and street address data.

8. The method of claim 7, wherein the client device is a wireless mobile device coupled to the access point over a wireless network, and wherein the wireless network comprises one or an 802.11 wireless network and an 802.16 wireless network.

9. The method of claim 7, wherein the client device is a wired device coupled to the access point over a wired network.

10. A machine-readable medium including instructions which when executed in a processing system provides geographic location of a mobile client device by:
searching for broadcasts of geographic location transmitted by an access point over a network; and
resending found geographic location information in a first application layer protocol to a service provided by a server coupled to the access point over a network, wherein the application accepts the geographic location of the access point as the geographic location of the client device.

11. The medium of claim 10, wherein the service provided by the server requires the geographic location and is used by the client.

12. The medium of claim 10, wherein the geographic location is transmitted to the client device by one of broadcasting to the client device at pre-defined time intervals, and transmitting to the client device from the access point in response to a query transmitted from the client device to the access point.

13. The medium of claim 10, wherein the network comprises the Internet, and wherein the geographic information is inserted at the Application layer of a TCP/IP network model.

14. A network system comprising:
a wireless mobile device coupled to an access point over a wireless network, the wireless mobile device configured to derive its own geographic location from a geographic location of the access point; and
a wide area network coupling the access point to a service provider, the service provider configured to provide a service that requires a geographic location of the mobile device.

15. The network system of claim 14, wherein the geographic location of the access point is determined by one of global positioning system data, user input data, and database provided data.

16. The network system of claim 14, wherein the wireless mobile device derives its own geographic location by receiving the geographic location of the access point, and wherein the access point is configured to transmit the client device by one of broadcasting to the client device at a pre-defined time and transmitting to the client device from the access point in response to a query transmitted from the client device to the access point

17. The network system of claim 16, wherein the wireless mobile device is configured to insert its own geographic location information into an application protocol for the service provided by the service provider.

18. The network system of claim 17, wherein the wide area network is a TCP/IP network, and the geographic information is inserted at the Application layer of a TCP/IP network model.

19. The network system of claim 18, wherein the wireless network comprises an 802.11 network.

20. The network system of claim 19, wherein the geographic location comprises one of latitude, longitude, elevation data, and street address data.

21. A method comprising:
determining a geographic location of an access point coupled to a client device over a first network;
storing the geographic location in a memory coupled to the access point;
providing the geographic location of the access point to an application service provider coupled to the client device, wherein the geographic location of the access point is adopted as the location of the client device for purposes of geographic context used by an application provided by the application service provider.
